(19) United States
(12) Patent Application Publication
(10) Pub. No.: US 2016/0293019 A1
(43) Pub. Date: Oct. 6, 2016

(54) METHOD OF MEASURING STATE OF DRONE

(71) Applicant: Korea University Research and Business Foundation, Seoul (KR)

(72) Inventors: Hwang Nam Kim, Seoul (KR); Seung Ho Yoo, Seoul (KR); Suk Kyu Lee, Seoul (KR); Jong Tack Jung, Seoul (KR); Kang Ho Kim, Busan (KR); Albert Yong Joon Chung, Seoul (KR); Ji Yeon Lee, Gyeonggi-Do (KR)

(73) Assignee: Korea University Research and Business Foundation, Seoul (KR)

(21) Appl. No.: 15/007,343

(22) Filed: Jan. 27, 2016

(30) Foreign Application Priority Data
Apr. 1, 2015 (KR) 10-2015-0046276

(51) Int. Cl. G08G 5/00; G08G 5/04; G01S 19/13; B64C 39/02

(52) U.S. Cl. CPC G08G 5/0069; B64C 39/024; G08G 5/04; G01S 19/13; B64C 2201/146

(57) ABSTRACT

Disclosed is a method of measuring a state of a drone. The method of measuring the state of the drone in a state in which a plurality of drones and a ground control station (GCS) are connected through a wireless network includes measuring, by a first drone, its own state based on collected information, requesting, by the first drone, a second drone or the GCS connected through the network to provide correction information and receiving the correction information from the second drone or the GCS, and comparing, by the first drone, information about the measured state with the received correction information, analyzing an error, and correcting the error.

### CROSS-REFERENCE TO RELATED APPLICATION

This application claims priority to and the benefit of Korean Patent Application No. 2015-0046276, filed on Apr. 1, 2015, the disclosure of which is incorporated herein by reference in its entirety.

### BACKGROUND

1. Field of the Invention

The present disclosure relates to a method of measuring a state of a drone. More particularly, the present disclosure relates to a drone state measurement method of enabling each drone to accurately measure its own state so as to properly perform a mission assigned to the drone in a drone fleet system constituted of a plurality of drones which are unmanned flight vehicles.

2. Discussion of Related Art

Drones include all flight vehicles which are remotely controlled or fly according to prior information in a state in which nobody boards the vehicle such as an unmanned aerial vehicle (UAV), an unmanned plane, and an unmanned flight vehicle. A drone fleet system refers to a group of drones and a ground control station (GCS) for jointly processing one or more missions.

Drone-related technology is continuously developing. For example, the drone was initially mainly utilized for a target of a guided weapon or a projectile. However, the utilization range of the drone has been recently extended because the drone has also been utilized as an unmanned surveillance aircraft such as Global Hawk. Further, with the development of a micro electro mechanical system (MEMS) inertial sensor and a digital microcontroller, a flight control device may also be mounted in an aircraft such as a remote control plane, a helicopter, or a multi-copter. Consequently, the drones have become widespread in use for the private sector.

However, because the drones are basically assumed to be manipulated by people at close distances, they need to directly manipulate the drones based on geographical features/facility information about flight places and this becomes a heavy burden for operators. Also, when the drone performs a mission, the drone analyzes its own state or a peripheral environment around the drone based on its own collected information. In the case of the drone, a weight capable of being carried by the drone is limited due to limited thrust. Accordingly, high-performance sensors (for example, a global positioning system (GPS) sensor, a velocity sensor, a gyroscope, etc.) are not used in the drones and sensors having relatively low accuracy may be used in the drones. Because of this, the accuracy of information about a state of the drone measured or estimated using the sensors mounted in the drone is degraded and this becomes a factor of preventing the drone from performing a given mission at an accurate position in a specific region. This may become a factor in a collision between the drones and a collision with an environmental object or a facility.

On the other hand, when a flight vehicle is used for aerial photography, a GCS provided by a manufacturer of a flight controller is used to reduce the above-described burden. However, because a user needs to directly set a flight path and a destination even in the above-described case and the GCS does not have information about a flight environment or peripheral facilities and does not utilize the information, the information needs to be considered when the user sets the path. For example, although the GCS provides a function of displaying peripheral geography based on a satellite photo or map, information about an altitude in a peripheral environment or a facility is absent in the satellite photo or the map and it is difficult to support path setting based on the geographical information. In addition, there is no function of simultaneously managing drones in an environment in which a plurality of drones are used in one region. Accordingly, when the GCS is utilized, it is difficult to prevent a drone from colliding with an environmental object, a facility, or another drone when the drones perform the mission.

### SUMMARY OF THE INVENTION

The present disclosure is directed to provide a drone state measurement method of accurately measuring a state of a drone for accurately measuring the state of the drone to prevent an accidental collision from occurring when the drone performs a mission.

Also, the present disclosure is directed to provide a drone state measurement method of correcting a sensor error of a drone using error correction information remotely generated by a sensor with high accuracy and measuring the state of the drone using corrected information.

Also, the present disclosure is directed to provide a drone state measurement method of receiving error correction information from a GCS or other peripheral drones and measuring the state of the drone using information corrected by the error correction information.

In some scenarios, there is provided a method of measuring a state of a drone in a state in which a plurality of drones and a GCS are connected through a wireless network, the method including: measuring, by a first drone, its own state based on collected information; requesting, by the first drone, a second drone or the GCS connected through the network to provide correction information and receiving the correction information from the second drone or the GCS; and comparing, by the first drone, information about the measured state with the received correction information, analyzing an error, and correcting the error.

The receiving of the correction information may include receiving correction information including GPS measurement error correction information for improving a position measurement error of a GPS device mounted in the first drone and altitude measurement error correction information for improving an altitude measurement error of an altitude measurement sensor mounted in the first drone.

The receiving of the correction information may include receiving at least one of correction information directly generated by the GCS based on information collected using sensors mounted in the GCS and correction information received by the GCS from another neighboring GCS.

The receiving of the correction information may include receiving GPS measurement error correction information generated by the GCS based on a satellite signal and coordinate information acquired by each of a plurality of GPS devices mounted in the GCS.

The receiving of the correction information may include transmitting information about an atmospheric pressure measured by the first drone to the GCS when the first drone requests the correction information and receiving altitude measurement error correction information generated by the GCS based on an altitude and an atmospheric pressure of the GCS measured by the GCS and the information about the atmospheric pressure measured by the first drone.

The receiving of the correction information may include receiving an altitude and an atmospheric pressure of the GCS measured by the GCS.

The correcting of the error may include calculating an altitude of the drone based on information about an atmospheric pressure measured by the first drone and the received altitude and atmospheric pressure of the GCS, comparing an altitude actually measured by the first drone with the calculated altitude, and correcting the error.

The receiving of the correction information may include receiving at least one of correction information generated based on information collected by the second drone and correction information received from a third drone connected to the second drone through the network.

In those or other scenarios, there is provided a method of measuring a state of a drone in a state in which a plurality of drones and a GCS are connected through a wireless network. The method includes: acquiring a satellite signal and coordinate information of the GCS from each of first and second GPS devices mounted in the GCS; analyzing, by the GCS, an error of the satellite signal based on the coordinate information; generating, by the GCS, GPS measurement error correction information based on an error analysis result; and transferring, by the GCS, the GPS measurement error correction information to the drone.

The acquiring of the satellite signal and the coordinate information may include: acquiring a satellite signal of the GCS from a first GPS device which is the same as a GPS device mounted in the drone; and acquiring coordinate information of the GCS from a second GPS device which is relatively more accurate than the first GPS device.

The analyzing of the error may include: calculating geographical positions of the GCS and a GPS satellite based on the satellite signal and the coordinate information; calculating a distance between the GCS and the GPS satellite based on geographical position information of the GCS and the GPS satellite; calculating an estimated arrival time taken until a message transmitted from the GPS satellite arrives at the GCS based on the calculated distance; measuring an actual arrival time taken until the message transmitted from the GPS satellite arrives at the GCS; and comparing the estimated arrival time with the actual arrival time.

The measuring of the actual arrival time may include measuring the actual arrival time by comparing time information contained in the message transmitted from the GPS satellite with time information of the GCS.

The GCS may iterate the acquiring of the satellite signal and the coordinate information, the analyzing of the error, and the generating of the GPS measurement error correction information for each preset cycle.

The present disclosure also relates to a method of measuring a state of a drone. According to the method, it may measure an accurate state of the drone by correcting a sensor error of the drone using remotely generated sensor error correction information of the drone and measuring the state of the drone using corrected information. Accordingly, it can prevent a danger of an accidental collision of the drone in advance and hence increase the efficiency of mission execution.

Also, the present solution is not merely limited to the drone field. The present solution can be used as the original technology of the drone and can be used in research and development for new fields in the future.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings.

FIG. 1 is a configuration diagram illustrating a general system for a drone network to which the present solution is applied.

FIGS. 2 and 3 are sequence diagrams illustrating schematic processing procedures for a method of measuring a state of a drone.

FIGS. 4 and 5 are processing flowcharts illustrating a method of measuring a state of a drone.

FIGS. 6 and 7 are processing flowcharts illustrating a method of measuring a state of a drone.

### DETAILED DESCRIPTION

While the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms “first,” “second,” “A,” “B,” etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements.

The terminology used herein to describe embodiments of the invention is not intended to limit the scope of the invention. The articles “a,” “an,” and “the” are singular in that they have a single referent, however, the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, components, and/or combinations thereof but do not preclude the presence or addition of one or more other features, items, steps, operations, elements, components, and/or combinations thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Hereinafter, preferred embodiments according to the present invention will be described in detail with reference to the accompanying drawings. Throughout this specification and the claims, when a certain part includes a certain component, it means that another component may be further included not excluding other components unless otherwise defined.

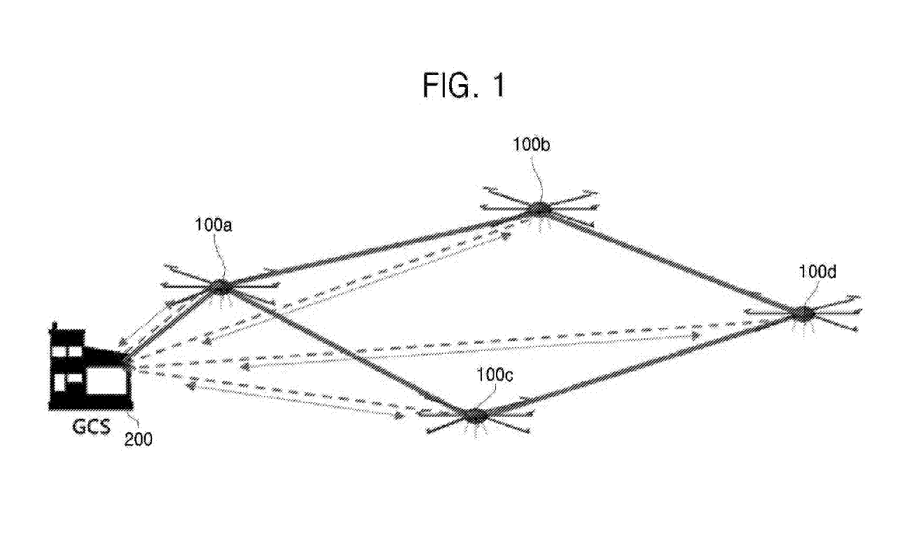

FIG. 1 is a configuration diagram illustrating a general system for a drone network to which the present solution is applied. Referring to FIG. 1, the drone network to which the present solution is applied is controlled by a GCS 200 and configured to include a plurality of drones 100a, 100b, 100c, and 100d constituting a fleet. Here, the drone includes all flight vehicles which are remotely aviated or aviate according to prior information in a state in which no person boards the vehicle such as a UAV, an unmanned plane, and an unmanned flight vehicle. A drone fleet is a group of drones which jointly accomplish one mission. The drones are managed in units of fleets without being managed as single objects and the drone fleet is configured to perform a mission which is difficult to be independently accomplished by one drone. In FIG. 1, an example in which the above-described four drones 100a, 100b, 100c, and 100d constitute the fleet and provide a network service under control of the GCS 200 is illustrated.

The present solution is directed to accurately detect a state such as an altitude or a position of the drone so that a drone colliding with another drone around the drone, a peripheral environmental object, or a facility is prevented when a plurality of drones are in units of fleets as described above. For this, the state of the drone may be accurately measured by correcting state information generated by the drone using error correction information generated remotely (for example, by “another drone,” the “GCS,” or the like located around the drone whose state is desired to be measured).

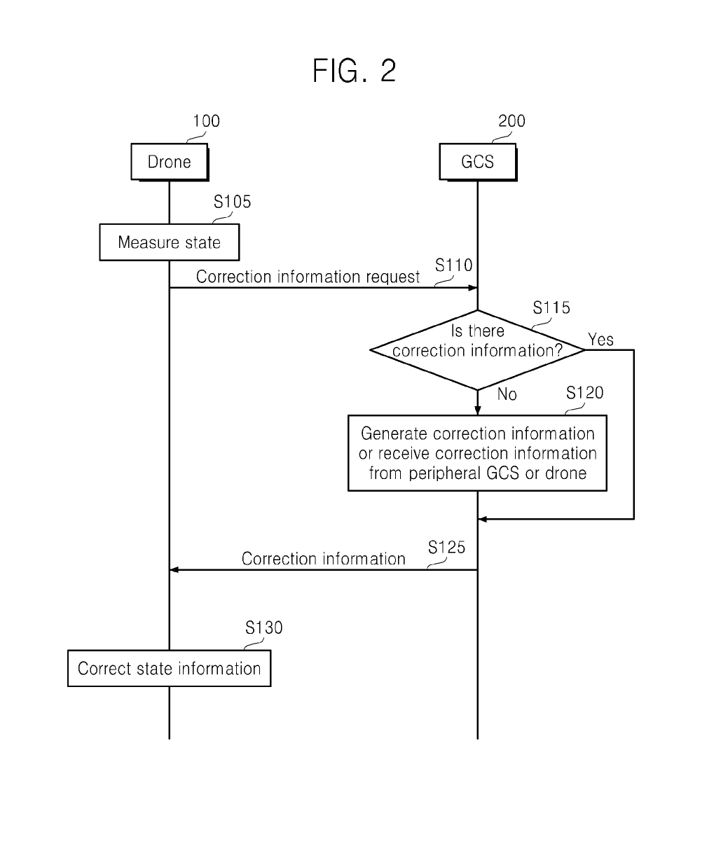

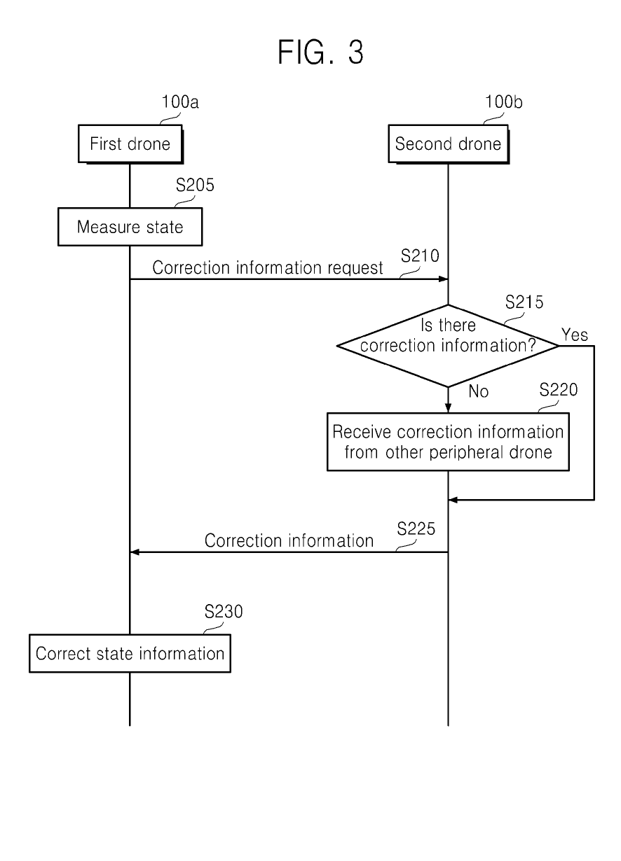

FIGS. 2 and 3 are sequence diagrams illustrating schematic processing procedures for a method of measuring a state of a drone. FIG. 2 illustrates an example of a processing procedure of correcting an error of the drone using correction information received from the GCS. FIG. 3 illustrates an example of a processing procedure of correcting an error using correction information received from a peripheral drone.

Referring to FIG. 2, in step S105, the drone 100 whose state is desired to be measured measures its own state (for example, flight altitude, position information, or the like) based on its own collected information.

In step S110, the GCS 200 is requested to provide correction information for correcting the measurement result.

Then, in step S115, the GCS 200 determines whether the correction information is inside the GCS 200. In step S120, the GCS 200 autonomously generates the correction information or receives the correction information from a peripheral GCS or drone when the correction information is not inside the GCS 200. In step S125, the GCS 200 transfers the correction information to the drone 100. At this time, when the correction information is inside the GCS 200, the GCS 200 may transfer the correction information. Otherwise, the GCS 200 may transfer the correction information obtained in step S120.

In step S130, the drone 100 corrects the state information. That is, the drone 100 analyzes an error by comparing the state measured in step S105 with the correction information received in step S125 and corrects the error.

At this time, the correction information may include GPS measurement error correction information for improving a position measurement error of a GPS device mounted in the drone 100 or altitude measurement error correction information for improving an altitude measurement error of an altitude measurement sensor mounted in the drone 100.

When the drone 100 requests the GPS measurement error correction information, the GCS 200 acquires a satellite signal and coordinate information of the GCS 200 from each of a plurality of GPS devices mounted in the GCS 200 and generates GPS measurement error correction information based on the satellite signal and the coordinate information in step S120. In step S125, the GCS 200 transmits the GPS measurement error correction information to the drone 100.

On the other hand, when the drone 100 requests the altitude measurement error correction information, the drone 100 also transmits information about its own measured atmospheric pressure to the GCS 200 in step S110 and the GCS 200 generates the altitude error correction information based on an altitude and an atmospheric pressure measured by the GCS 200 and the information about the atmospheric pressure measured by the drone 100 in step S120. In step S125, the GCS 200 transmits the altitude measurement error correction information to the drone 100.

Alternatively, when the drone 100 requests only an altitude and an atmospheric pressure of the GCS 200 in step S110, the GCS 200 measures its own altitude and atmospheric pressure in step S120 and transmits information on the altitude and the atmospheric pressure to the drone 100 in step S125. Then, the drone 100 calculates the altitude of the drone 100 based on the information of its own measured atmospheric pressure and the received information on altitude and atmospheric pressure of the GCS 200 in step S130 and corrects the error after comparing the altitude actually measured by the drone 100 in step S105 with the calculated altitude.

In step S120, it is preferable for the GCS 200 to use an altitude based on a sea level for altitude measurement error correction. An example of a method of measuring the altitude based on the sea level is shown in Mathematical Equation (1).

$$altitude = 44330 * ( 1 - {( \frac{p}{{p}_{0}} )}^{5.255} ) \qquad ( 1 )$$

Here, altitude is an altitude based on the sea level, p is an actual atmospheric pressure, and p0 is an atmospheric pressure at the sea level.

Referring to FIG. 3, in step S205, a first drone 100a whose state is desired to be measured measures its own state (for example, flight altitude, position information, or the like) based on its own collected information.

In step S210, a second drone 100b is requested to provide correction information for correcting the measurement result.

Then, in step S215, the second drone 100b determines whether the correction information is inside the second drone 100b. In step S220, the second drone 100b autonomously generates the correction information or receives the correction information from another peripheral drone (for example, a third drone 100c or the like) when the correction information is not inside the second drone 100b. In step S225, the second drone 100b transfers the correction information to the first drone 100a. At this time, when the correction information is inside the second drone 100b, the second drone 100b may transfer the correction information. Otherwise, the second drone 100b may transfer the correction information obtained in step S220.

In step S230, the first drone 100a corrects the state information. That is, the first drone 100a analyzes an error by comparing the state measured in step 5205 with the correction information received in step S225 and corrects the error.

On the other hand, although not illustrated in FIGS. 2 and 3, the GCS 200 or the second drone 100b having the correction information or generating or collecting the correction information in step S120 or S220 may transmit the correction information of the other peripheral drone or GCS in response to the request of the other peripheral drone or GCS.

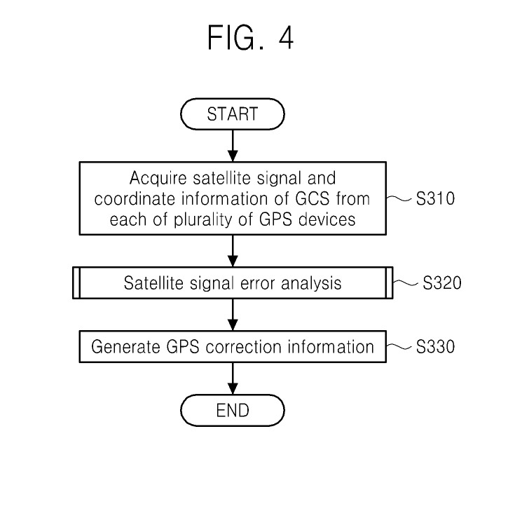

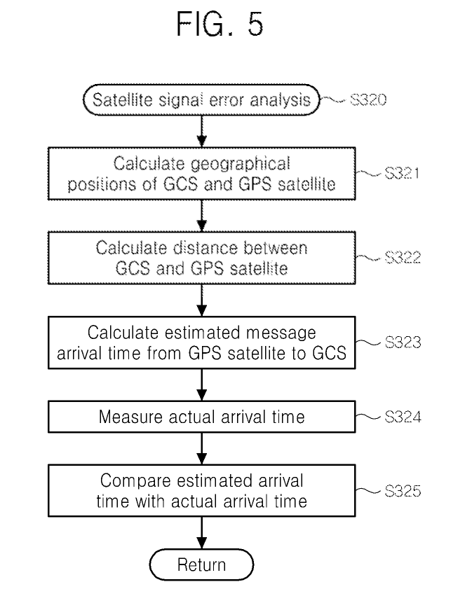

FIGS. 4 and 5 are processing flowcharts illustrating a method of measuring a state of a drone. Also, FIGS. 4 and 5 illustrate a series of processing processes in which the GCS generates measurement error correction information of a GPS device. That is, FIG. 4 illustrates an example of a series of processing processes in which the GCS generates correction information for correcting a measurement error of the GPS device mounted in the drone and FIG. 5 illustrates an example of a further detailed processing process for an error analysis process illustrated in FIG. 4.

First, referring to FIG. 4, in step S310, the GCS acquires a satellite signal and coordinate information of the GCS from each of a plurality of GPS devices mounted in the GCS. At this time, one (hereinafter referred to as a ‘first GPS device’) of the plurality of GPS devices mounted in the GCS is the same as the GPS device mounted in the drone and the other (hereinafter referred to as a ‘second GPS device’) is not mounted in the drone, but is an accurate GPS device. The first GPS device acquires a satellite signal and the second GPS device acquires coordinate information of the GCS.

The GCS analyzes an error in the satellite signal based on the coordinate information acquired in step S310 in step S320 and generates GPS measurement error correction information based on the error analysis result in step S330.

When the GPS measurement error correction information is generated as described above, the GCS transfers the GPS measurement error correction information to the drone so that the GPS measurement error of the drone may be corrected (although not illustrated).

Referring to FIG. 5, the satellite signal error analysis process of step S320 is as follows.

In step S321, geographical positions of the GCS and the GPS satellite are calculated by referring to the following Mathematical Equations (2).

x=R cos(lat)sin(lng),

y=R cos(lat)cos(lng),

z=R sin(lat) (2)

Here, ‘R’ denotes a distance from a satellite orbit in the case of the GPS satellite or a distance from the Earth center in the case of the GCS. ‘lat’ denotes a latitude of the satellite or GCS and ‘lng’ denotes a longitude of the satellite or GCS.

That is, based on Mathematical Equation (2), coordinate values xsat, ysat, and zsat of the GPS satellite and coordinate values xGCS, yGCS, and zGCS of the GCS are calculated.

In step S322, a distance between the GCS and the GPS satellite is calculated based on the geographical position information of the GCS and the GPS satellite. For this, the distance l between the GCS and the GPS satellite is calculated by applying the above-described coordinate values to the following Mathematical Equation (3).

l=\sqrt{(x_{GCS}−xₛₐₜ)²+(y_{GCS}−yₛₐₜ)²+(z_{GCS}−zₛₐₜ)²} (3)

In step S323, an estimated arrival time taken until a message transmitted from the GPS satellite arrives at the GCS is calculated based on the calculated distance. For this, the estimated arrival time t is calculated by applying the distance l between the GCS and the GPS satellite to the following Mathematical Equation (4).

$$t = \frac{l}{c} \qquad ( 4 )$$

Here, c denotes the velocity of light.

In step S324, an actual arrival time t′ taken until the message transmitted from the GPS satellite arrives at the GCS is measured. For this, the GCS may measure the actual arrival time t′ after comparing time information contained in the message transmitted from the GPS satellite with time information of the GCS.

In step S325, the estimated arrival time t is compared with the actual arrival time t′. That is, error correction information is generated with respect to all satellites by calculating a difference between the estimated arrival time t and the actual arrival time t′.

On the other hand, it is preferable for the GCS to update GPS error correction information by iterating a series of processing processes of generating GPS measurement error correction information illustrated in FIGS. 4 and 5 for each preset cycle (once per hour) and provide the updated correction information when a peripheral drone requests the correction information.

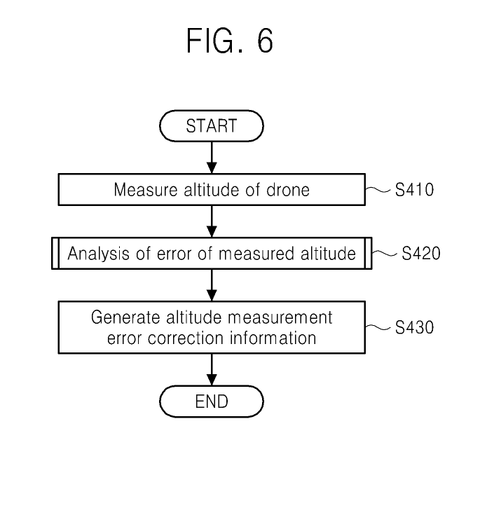

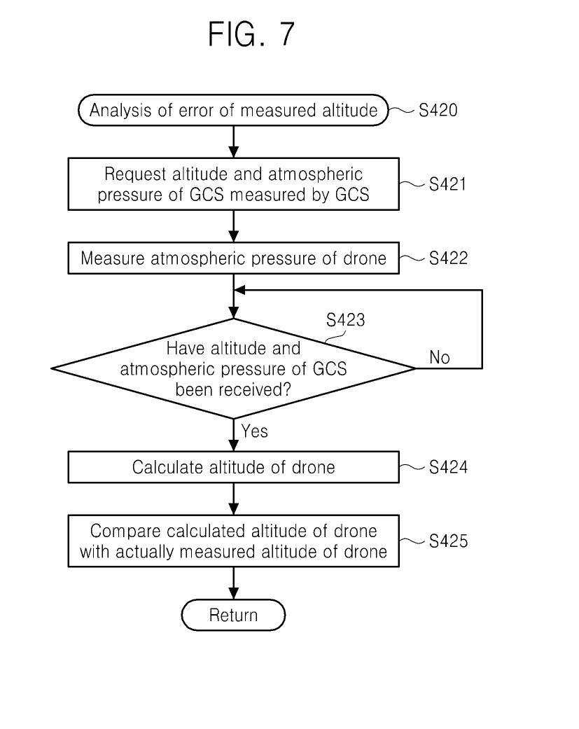

FIGS. 6 and 7 are processing flowcharts illustrating a method of measuring a state of a drone. Also, FIGS. 6 and 7 illustrate a series of processing processes in which the drone or GCS generates altitude measurement error correction information of the drone. That is, FIG. 6 illustrates an example of a series of processing processes of generating correction information for correcting an altitude value measured by the drone, and FIG. 7 illustrates an example of a further detailed processing process for an error analysis process illustrated in FIG. 6.

First, referring to FIG. 6, in step S410, the altitude of the drone is measured using an altitude sensor mounted in the drone.

In step S420, an error of the measured altitude is analyzed using information measured by a sensor mounted in the GCS. In step S430, the altitude measurement error correction information is generated based on the error analysis result.

Referring to FIG. 7, an error analysis process on the altitude measured in step S420 is as follows.

First, the drone measuring its own altitude in step S410 of FIG. 6 requests an altitude and an atmospheric pressure of the GCS measured by the GCS in step S421 and measures an atmospheric pressure of a position at which the drone is currently located using a barometer mounted in the drone in step S422.

On the other hand, the GCS receiving a request for altitude and atmospheric pressure measurement results from the drone measures the altitude using the GPS device mounted in the GCS in response to the request, measures an atmospheric pressure and a temperature on the altitude at which the GCS is located, and transfers the measured atmospheric pressure and temperature to the drone.

The drone receiving the altitude and the atmospheric pressure of the GCS in step S423 calculates its own altitude in step S424. For this, the drone applies the received altitude (an altitude of the GCS based on the sea level) and atmospheric pressure of the GCS and the atmospheric pressure measured by the drone to the following Mathematical Equation (5).

$${altitude}_{drone} = 44330 * [ 1 - \{ {( \frac{{p}_{drone}}{{p}_{GCS}} )}^{5.255} * ( 1 - \frac{{altitude}_{GCS}}{44330} ) \} ] \qquad ( 5 )$$

Here, altitude_{drone} denotes an altitude of the drone based on the sea level, Pdrone denotes an atmospheric pressure of the drone, altitudeGCS denotes an altitude of the GCS based on the sea level, and PGCS denotes an atmospheric pressure of the GCS.

In step S425, the calculated altitude of the drone is compared with the actually measured altitude of the drone. That is, an error is analyzed by calculating a difference between the calculated altitude of the drone and the actually measured altitude of the drone.

At this time, any of the drone or GCS may perform the series of processing processes. For example, the drone receiving the altitude and atmospheric pressure information of the GCS from the GCS may perform the series of processing processes and the GCS receiving the atmospheric pressure measurement result of the drone from the drone may perform the series of processing processes.

Meanwhile, the exemplary solutions may be prepared by a program which is executable in a computer and implemented in a general-purpose digital computer operating the program by using a computer-readable recording medium.

The computer-readable recording medium includes magnetic storage media (e.g., a ROM, a floppy disk, a hard disk, and the like) and storage media such as optical reading media (e.g., a CD-ROM, a DVD, and the like).

The present invention has been described with reference to concrete examples. A person skilled in the art would understand that the present invention can be realized as a modified form within a scope which does not depart from the essential characteristics of the present invention. Accordingly, the disclosed examples must be considered in their illustrative aspect and not in their limitative aspect. The scope of the present invention is shown not in the aforesaid description but in the appended claims, and all differences within a scope equivalent thereto should be interpreted as being included in the present invention.

What is claimed is:

1. A method of measuring a state of a drone in a state in which a plurality of drones and a ground control station (GCS) are connected through a wireless network, the method comprising:
measuring, by a first drone, its own state based on collected information;
requesting, by the first drone, a second drone or the GCS connected through the network to provide correction information and receiving the correction information from the second drone or the GCS; and
comparing, by the first drone, information about the measured state with the received correction information, analyzing an error, and correcting the error.

2. The method according to claim 1, wherein the receiving of the correction information includes:
receiving correction information including global positioning system (GPS) measurement error correction information for improving a position measurement error of a GPS device mounted in the first drone and altitude measurement error correction information for improving an altitude measurement error of an altitude measurement sensor mounted in the first drone.

3. The method according to claim 2, wherein the receiving of the correction information includes:
receiving at least one of correction information directly generated by the GCS based on information collected using sensors mounted in the GCS and correction information received by the GCS from another neighboring GCS.

4. The method according to claim 3, wherein the receiving of the correction information includes:
receiving GPS measurement error correction information generated by the GCS based on a satellite signal and coordinate information acquired by each of a plurality of GPS devices mounted in the GCS.

5. The method according to claim 3, wherein the receiving of the correction information includes:
transmitting information about an atmospheric pressure measured by the first drone to the GCS when the first drone requests the correction information and receiving altitude measurement error correction information generated by the GCS based on an altitude and an atmospheric pressure of the GCS measured by the GCS and the information about the atmospheric pressure measured by the first drone.

6. The method according to claim 3, wherein the receiving of the correction information includes:
receiving an altitude and an atmospheric pressure of the GCS measured by the GCS.

7. The method according to claim 6, wherein the correcting of the error includes:
calculating an altitude of the drone based on information about an atmospheric pressure measured by the first drone and the received altitude and atmospheric pressure of the GCS, comparing an altitude actually measured by the first drone with the calculated altitude, and correcting the error.

8. The method according to claim 2, wherein the receiving of the correction information includes:
receiving at least one of correction information generated based on information collected by the second drone and correction information received from a third drone connected to the second drone through the network.

9. A method of measuring a state of a drone in a state in which a plurality of drones and a GCS are connected through a wireless network, the method comprising:
acquiring a satellite signal and coordinate information of the GCS from each of first and second GPS devices mounted in the GCS;
analyzing, by the GCS, an error of the satellite signal based on the coordinate information;
generating, by the GCS, GPS measurement error correction information based on the error analysis result; and
transferring, by the GCS, the GPS measurement error correction information to the drone.

10. The method according to claim 9, wherein the acquiring of the satellite signal and the coordinate information includes:
acquiring a satellite signal of the GCS from a first GPS device which is the same as a GPS device mounted in the drone and acquiring coordinate information of the GCS from a second GPS device which is relatively more accurate than the first GPS device.

11. The method according to claim 9, wherein the analyzing of the error includes:
calculating geographical positions of the GCS and a GPS satellite based on the satellite signal and the coordinate information;
calculating a distance between the GCS and the GPS satellite based on the geographical positions of the GCS and the GPS satellite;
calculating an estimated arrival time taken until a message transmitted from the GPS satellite arrives at the GCS based on the calculated distance;
measuring an actual arrival time taken until the message transmitted from the GPS satellite arrives at the GCS; and
comparing the estimated arrival time with the actual arrival time.

12. The method according to claim 11, wherein the measuring of the actual arrival time includes:
measuring the actual arrival time by comparing time information contained in the message transmitted from the GPS satellite with time information of the GCS.

13. The method according to claim 9, wherein the GCS iterates the acquiring of the satellite signal and the coordinate information, the analyzing of the error, the generating of the GPS measurement error correction information and the transferring the GPS measurement error correction information for each preset cycle.
